(19) United States
(12) Patent Application Publication
(10) Pub. No.: US 2015/0360463 A1
(43) Pub. Date: Dec. 17, 2015

(54) Vacuum Electronic Device 3-D Printing

(71) Applicants: Laurence P. Sadwick, Salt Lake City, UT (US); Derrick K. Kress, Salt Lake City, UT (US); Ruey-Jen Hwu, Salt Lake City, UT (US)

(72) Inventors: Laurence P. Sadwick, Salt Lake City, UT (US); Derrick K. Kress, Salt Lake City, UT (US); Ruey-Jen Hwu, Salt Lake City, UT (US)

(21) Appl. No.: 14/738,823

(22) Filed: Jun. 12, 2015

Related U.S. Application Data
(60) Provisional application No. 62/011,506, filed on Jun. 12, 2014.

(51) Int. Cl. B41J 2/00; B33Y 30/00

(52) U.S. Cl. CPC B41J 2/00; B33Y 30/00

(57) ABSTRACT

A vacuum electronic device manufacturing system including a three dimensional printer.

### BACKGROUND

Vacuum Electronic Devices (VEDs) such as, but not limited to, microwave tubes (MWT) are used in a large number of applications including both commercial and military/defense. Examples of uses for MWTs include but are not limited to communications, radar, imaging, heating, processing including food processing, microwave ovens, and electronic warfare (EW) systems. In the microwave tube industry and other vacuum tube sectors, high purity metals are increasingly difficult and costly to procure. For example, vacuum-grade high purity copper (OFHC) and copper-nickel alloys such as Monel and cupronickel are highly desirable in MWT manufacturing processes because they are corrosion resistant, often stronger than steel, have a low coefficient of thermal expansion, have possess low outgassing properties, and can be welded and brazed, both to other metals and to metallized ceramics. However, these alloys are considered “niche” market materials and are therefore expensive and increasingly only available from fewer suppliers.

Replacement materials or material processes to make these alloys and to make parts out of these alloys are needed that can significantly stabilize the MWT material supply base while improving material and process reliability for improved vacuum integrity, manufacturing yield, corrosion resistance, and thermo-mechanical compatibility, resulting in longer life microwave tubes and decreased life-cycle cost. The main difficulty with many otherwise attractive alloys is the fact that metallic and non-metallic impurities infuse into the material and lead to undesirable consequences such as vacuum degradation, outgassing, brazing defects, and cathode poisoning, and a general decrease in passing product yield. In some cases, the coefficient of expansion of the impurity is greatly different than the alloy, thus leading to weakness and voids in the material. The weaknesses are often found during the microwave tube manufacturing process where brazing, welding, electro-plating, and heat cycling are commonplace. Impurities often cause virtual leaks to occur where vacuum integrity breaks down and the microwave tube ceases to function properly. In order to mitigate this risk, microwave tube manufacturers often have to perform additional processing and other steps on these materials to seal in the potential weak spot which adds cost and time to the manufacturing process while decreasing durability and product life.

Therefore there is a need to seek alternatives to improve existing manufacturing techniques for VED relevant metal alloys and/or to develop new materials suitable to replace existing vacuum-grade materials while maintaining VED compatible characteristics such as coefficients of thermal expansion, machinability, manufacturability, and thermal conductivity required by the industry.

### SUMMARY

Various embodiments of the present invention provide systems and methods for manufacturing vacuum electronic devices using three dimensional (3-D) printing.

The embodiments shown and discussed are intended to be examples of the present invention and in no way or form should these examples be viewed as being limiting of and for the present invention.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phrases do not necessarily refer to the same embodiment. Additional embodiments are disclosed in the following detailed description, the appended claims and the accompanying drawings.

### BRIEF DESCRIPTION OF THE FIGURES

A further understanding of the various embodiments of the present invention may be realized by reference to the Figures which are described in remaining portions of the specification. In the Figures, like reference numerals may be used throughout several drawings to refer to similar components.

FIG. 1 depicts a 3-D vacuum electronic device printer in accordance with some embodiments of the invention;

FIG. 2 depicts a barrel for beam stick testing which can be printed by the 3-D vacuum electronic device printer in accordance with some embodiments of the invention;

FIG. 3 depicts an envelope seal which can be printed by the 3-D vacuum electronic device printer in accordance with some embodiments of the invention;

FIG. 4 depicts a focus electrode blank which can be printed by the 3-D vacuum electronic device printer in accordance with some embodiments of the invention;

FIG. 5 depicts a gun envelope ring which can be printed by the 3-D vacuum electronic device printer in accordance with some embodiments of the invention;

FIG. 6 depicts a fixture which can be printed by the 3-D vacuum electronic device printer in accordance with some embodiments of the invention;

FIG. 7 depicts a gun face which can be printed by the 3-D vacuum electronic device printer in accordance with some embodiments of the invention;

FIG. 8 depicts a waveguide ridge as an example of a portion of a slow wave structure which can be printed by the 3-D vacuum electronic device printer in accordance with some embodiments of the invention;

FIG. 9 depicts a cell of a ladder-based coupled cavity as an example of another portion of a slow wave structure which can be printed by the 3-D vacuum electronic device printer in accordance with some embodiments of the invention;

FIG. 10 depicts a loss block which can be printed by the 3-D vacuum electronic device printer in accordance with some embodiments of the invention;

FIG. 11 depicts a magnet shim which can be printed by the 3-D vacuum electronic device printer in accordance with some embodiments of the invention; and

FIG. 12 depicts a collector stage which can be printed by the 3-D vacuum electronic device printer in accordance with some embodiments of the invention.

### DETAILED DESCRIPTION OF THE INVENTION

The present invention uses processes involving 3-dimensional (3-D) printing of vacuum electronic devices in, for example, but not limited to, copper (Cu), nickel (Ni) and CuNi alloys and CuNi containing alloys in addition to other materials suitable for VED use including but not limited to MWT use.

The present invention includes processes for eliminating or significantly reducing machining of Cu, Ni and CuNi parts and implementing for example but not limited to powder metallurgy approaches to reducing impurities in potential materials that, with reduced impurities, would otherwise be suitable for VED use.

The present invention uses high purity metal material and processing alternatives for vacuum electronic devices (VEDs) including microwave tube (MWT) production that meet or exceed the performance and reliability of existing materials and processes while potentially significantly decreasing the cost, time, manual labor of fabricating components and assembling VEDs and MWTs.

The innovative materials and approaches for the present invention have VED applications and applicability to commercial microwave tubes and other applications and markets including but not limited to agencies and commercial customers that use microwave tubes for a wide variety of radar, telecommunications, medical therapy, food and materials processing application. In addition, various scientific applications (such as plasma fusion and materials research, food and other processing, drying, induction heating, etc.) exist that also rely on microwave tube technology and other industrial and commercial applications and markets.

The present invention uses 3-D printing and additive manufacturing including but not limited to a Cu/Ni and other metal and insulator including ceramics printer or printers to create, fabricate, manufacture, etc. vacuum electronic device (VED) parts including but not limited to electron guns and electron gun components and parts, slow wave structures and slow wave structure components and parts and collector parts and components. The present invention also creates peripheral vacuum equipment used in the manufacturing of VEDs and MWTs such as Cu vacuum gaskets, Ion Pump components, fixtures, electrical contacts, etc.

The 3-D printer prints Cu structures and parts or complete VEDs for the VEDs and can provide a manufacturable, cost reduced and flexible product line of copper and copper alloys that can be, but is not limited to being, used in vacuum electronic devices such as magnetrons, klystrons and TWTs, gyrotrons, phototubes, photomultipliers, cross field devices, etc.

The present invention replaces the more traditional and conventional methods for making, for example, Cu and CuNi alloys and parts for vacuum electron devices (VEDs) from these materials including CNC machining, grinding, laser cutting, water jet, CVD, CMP, EDM, and others. The present invention involves using a three-dimensional printing process referred to as 3-D printing in which a 3-D metal printer liquefies Cu and/or Ni to form high purity CuNi alloys into 3-D parts to form precision Cu and CuNi alloy (including Monel) parts directly without any conventional machining. This is extremely energy efficient, time saving, and extremely material usage efficient.

Cu wires, powders, solids, etc. can be liquefied and/or processed using other methods to provide ‘printable’ ultra-high purity Cu and ‘printable’ Ni leading to CuNi printed alloys.

Electrolytic grade Cu used in some embodiments, while very pure, is typically not expensive. It is electro-refined copper that is used in electrical wiring. Typically it ends up with purity levels of 99.995%.

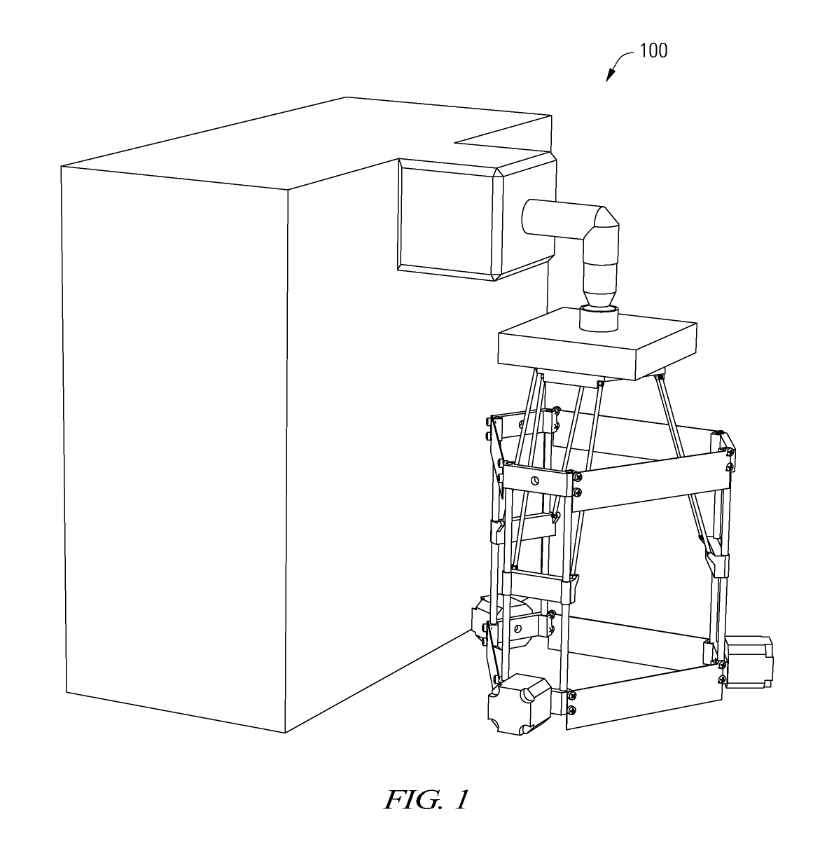

By maintaining ‘good’ vacuum conditions during melting and processing the present invention can produce virtually defect free Cu and CuNi alloys—which also applies to novel and innovative Cu and CuNi alloy 3-D printer parts and complete assemblies. The Cu and CuNi alloy 3-D printer can be either completely enclosed in and under a vacuum or an inert ambient environment (i.e., argon or nitrogen depending on the method of printing). Embodiments of the present invention can or cannot use binders of any type—only ultrapure copper and ultrapure Ni. An example embodiment of a Cu and CuNi 3-D printer 100 is shown in FIG. 1. Note that the entire 3-D Printer 100 is inside a vacuum enclosure/chamber so as not to oxidize the Cu. Such a printer can be used to print other metals, materials, oxides, nitrides, ceramics, insulators, alloys, metals, etc., combinations of these, etc. for VEDs and VED parts, components, systems, subassemblies, assemblies, fixtures including but not limited to process and test fixtures, etc.

Again, some embodiments of the present invention use electrolytic copper made by electrolytic refining of anode copper (that in the previous step was obtained by fire refining of blister copper), in some cases to an initial purity of at least 99.95 percent. For comparison, oxygen free high thermal conductivity (OFHC) copper grade 10100 contains 99.99% Cu, 0.0003 Fe, 0.0005 Sb, 0.0005 Oxygen, 0.0004 Sb and 0.0002 Te. Other impurities that can be present include in trace levels include carbon, lead, phosphorus, sulphur, zinc, and cobalt. The source of these impurities is mainly the sulphide ore body from which copper is extracted. Copper-nickel alloys could typically contain intentionally added alloying elements nickel, iron, manganese and tin and in addition contain trace levels of other Impurities. Because of large solidification range in Cu—Ni alloys, these alloy microstructures can exhibit compositional gradients across the dendrites and interdendritic regions due to segregation during conventional solidification processing. However these can be minimized by increased solidification rates during processing such as in incremental solidification—another 3-D printing approach employed in some embodiments.

Obtaining alloys for microwave tube manufacturing involves eliminating impurities with relatively low boiling points (high vapor pressures) which can provide an internal gas leak source. The present invention includes approaches to minimize these impurities and segregation that could provide such internal gas leak source by, for example, but not limited to, the use of high purity Cu and Ni and controlling processing conditions that minimize incorporation of impurities and segregation of impurities to grain boundaries.

The present invention involves high purity Cu, Cu—Ni and Ni for use in high vacuum, leak free, vacuum-tight components for VED applications.

Alloys can be prepared by melting and casting under high vacuum and by powder compaction and sintering. High purity Cu and Ni can be used to minimize and eliminate high vapor pressure impurities in the metal that can degrade vacuum.

An additional benefit, among many benefits provided by the vacuum electronic device 3-D printing system disclosed herein, is that vacuum electronic devices and parts can be designed in essentially most any shape or form (i.e., not just circular) including square, rectangular, oval, elliptical, hexagonal, etc. and, within reason, any arbitrary and/or odd shape with any number of sides (including curved sides) or aspect ratio. The CuNi printing can also be scaled up (or down) in size to accommodate much larger size cathodes as well as smaller sized cathodes and larger and smaller feature sizes and dimensions, respectively. The 3-D printer can also realize structures within structures, which is either difficult or essentially impossible to accomplish with current machining techniques, particularly if the structures within a structure have fine detail, thereby opening new possibilities for VED design and concept, implementations and applications and uses.

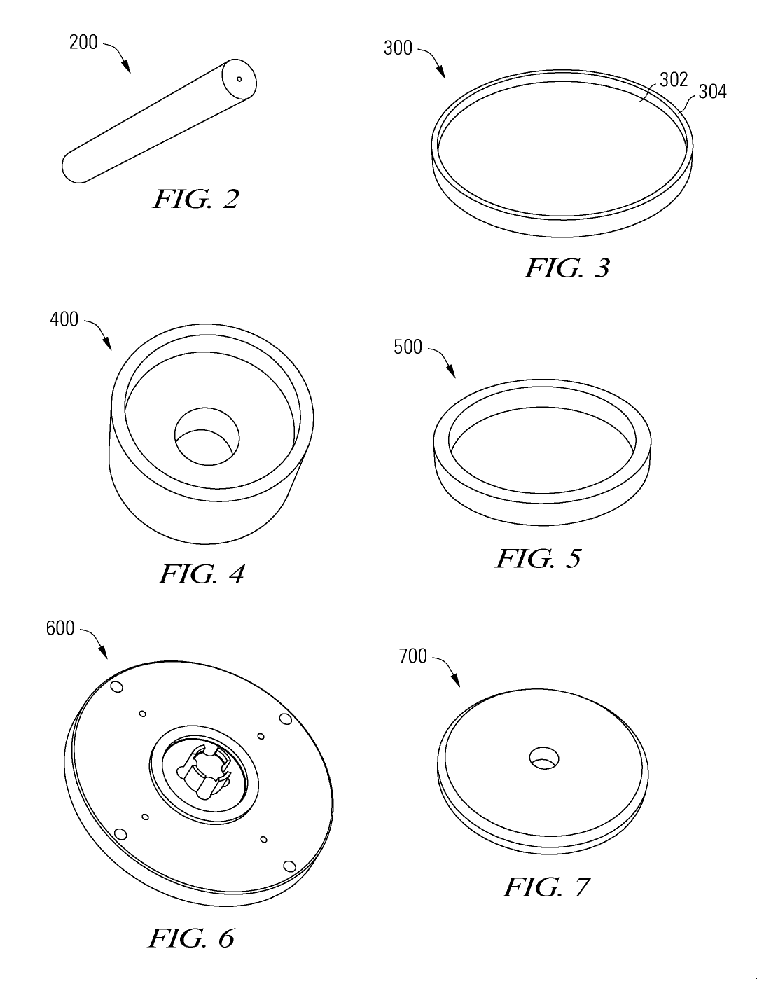

Examples of the parts that can be Cu and Cu/Ni 3-D printed include a barrel 200 (shown in FIG. 2) for beam stick testing, the outer vacuum envelope, etc. The present invention can also be used for the full slow wave structure (SWS) depending on feature size and geometry. The present invention allows for ultra-fine feature sizes on the scale of many slow wave structures especially slow wave structures for coupled cavity VEDs. For the collector stages of VEDs, conductive surfaces can be printed for electron beam current return. Parts, components, assemblies, VEDs, etc. can be other shapes other than round/symmetrical.

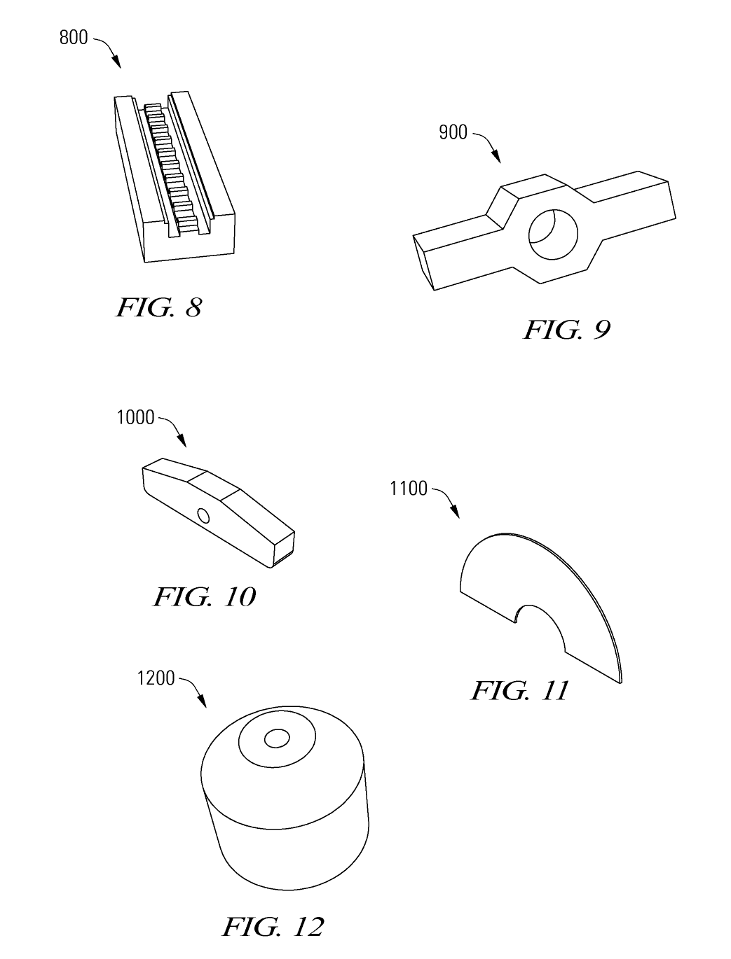

A number of examples of VED structures that can be printed by the 3-D printer are presented herein, however, the 3-D printer can be used to manufacture/print other VED devices/structures and is not limited the examples disclosed herein. The 3-D printer can be used to print envelope seals (e.g., 300, FIG. 3) which can include a solid base 302 with a lip 304, used to seal an electron gun envelope assembly. Only low tolerances are required as a welding seal can close small voids between parts. The 3-D printer can be used to print focus electrode blanks (e.g., 400, FIG. 4). Often, focus electrode blanks require precise geometry. However, a part can be 3-D printed in a blank form that contains printed low tolerance geometries, as well as excess material where post machining may be done to bring part into tolerance at a much lower cost than traditional machining. The 3-D printer can be used to print gun envelope rings (e.g., 500, FIG. 5). Electron guns typically require alternating ceramic and metal rings to provide insulated feed-through for electron gun electrostatic surfaces and the cathode heater. The seals can be constructed by 3-D printing and then quickly ground on either side to an acceptable brazing surface or can be further 3-D printed in, for example, a stacked configuration. The 3-D printer can be used to print fixtures (e.g., 600, FIG. 6). During the assembly and construction of a VED or MWT multiple fixtures are required to accomplish action items such as alignment, pressure application, heat shielding, mechanical support, temporary storage, and many others. By 3-D printing these parts the cost is reduced substantially. Many fixtures do not require precision features, but those that do require precision beyond the capabilities of the present invention may be further refined by post-machining/finishing to bring the already very accurate fixture into a higher tolerance class or use soon to be developed higher resolution 3-D printers, processes, techniques, technologies, approaches, methodologies, etc., combinations of these, etc. The present invention can manufacture not only VED/MWT parts, but most parts needed in the development and construction of such devices. The 3-D printer can be used to print gun faces (e.g., 700, FIG. 7). The gun face (e.g., 700) can be 3-D printed and if needed machined or micro-machined to precise dimensions if the precision of the 3-D printer is not sufficient by itself. The 3-D printer can be used to print traveling wave tube (TWT) slow wave structures (SWS), such as, but not limited to, the waveguide ridge 800 shown in FIG. 8 that can be used as part of a ladder-based SWS. 3-D printing can be used to print much more than just elemental Cu and/or Ni and/or CuNi alloys and compounds. As 3-D printing matures and resolution increases, small very expensive parts of TWT slow wave structures can be printed to adequate precision thereby dramatically reducing cost as well as increasing throughput by reducing delivery time and vendor delay. All parts can be plated or deposited post printing to provide the necessary surface conductivity requirements including if the needed material is not available for use with existing metal 3-D printing. Electro-polishing can be used and an effective procedure can be developed to reduce the effect the printer resolution has on the final part geometry. Physical vapor deposition (PVD) including but not limited to electron beam evaporation, sputtering and plasma deposition as well as all types and forms of chemical vapor deposition (CVD) can also be used to provide a finished product, part, component, sub-assembly, assembly, circuit, etc. including but not limited to cathodes, cathode heaters, grids, electrodes, electron guns, slow wave structures, collectors, metal to insulator seals, metal to ceramic seals, etc. As another example of a slow wave structure that can be printed by the 3-D printer, a cell 900 of a ladder-based coupled cavity is shown in FIG. 9. Other example parts that can be printed by the 3-D printer depicted in the drawings include a loss block 1000 (FIG. 10), a magnet shim 1100 (FIG. 11), and a collector stage 1200 (FIG. 12). Again, the 3-D printer is not limited to use in manufacturing any particular type of VED, VED part or fixture used in the manufacturing of a VED or VED part. 3-D printing can be used to fabricate all types helix and related structures with multi-octave bandwidths including helix, helices, ring and bar, etc., derivatives and hybrid devices, etc.

To obtain liquefied Cu in some embodiments, a wire feed is performed using a set of orifices that are differentially pumped which are just slightly larger than the wire diameter and can effectively be continuously fed into the Cu 3-D Printer fabrication system. This process can effectively achieve better results than conventional powder sintering, recrystallization, etc.

A number of methods and ways can be used to liquefy Cu and vast diversity of other elements, metals, compounds, alloys, insulators, ceramics including the use of vacuum encapsulated refractory wires surrounding and heating a refractory ceramic tube through which the copper is heated and flows through, laser-heating, electron beam heating, etc.

The present invention allows relative ease of low cost fabrication especially compared with current fabrication methods, as well as being highly flexible and adaptable.

Embodiments of the present invention include but are not limited to low cost metal 3-D printers that are controlled with an open-source micro-controller including the microcontroller code with vacuum compatible motors for 3 axis control and include highly sophisticated and sometimes complicated and expensive professional grade 3-D printers.

As disclosed above, the 3-D printer uses any suitable method to liquefy Cu and Ni and other materials including but not limited to refractory metals, precious metals, rare earth metals, compounds, alloys, etc. and also including methods to extrude these and additional materials. In some embodiments, the 3-D printer uses Boron Nitride (BN) capillary tubes that are heated and Cu powder is “poured” into the BN tubes. In some embodiments, the 3-D printer uses electron beam heating, laser heating, etc. or other techniques to melt materials to be used in the printing. The 3-D printer heats and deposits Cu and Ni to form the part(s) being manufactured, heating and flowing appropriate amounts of Cu onto Cu and ceramic substrates to construct more complicated and complete VED parts.

In some embodiments, the 3-D printer prints two-dimensional Cu layers and other layers made of, for example, but not limited to, elemental materials, alloys, eutectics, other or compounds, other known combinations of the following, etc.: ceramics, etc. of tungsten, copper, aluminum, molybdenum, tantalum, zirconium, gold, silver, nickel, iron, rare earth elements, cobalt, titanium, indium, platinum, palladium, iridium, rhodium, hafnium, zirconium, chromium, silicon, rhenium, osmium, magnesium, barium, beryllium, scandium, etc.

To Make 3-D Shapes.

Feed material for the Cu, CuNi, most all other appropriate elemental materials, alloys or compounds, ceramics, etc. of tungsten, copper, aluminum, molybdenum, tantalum, zirconium, gold, silver, nickel, iron, rare earth elements, cobalt, titanium, indium, platinum, palladium, iridium, rhodium, hafnium, zirconium, chromium, silicon, rhenium, osmium, magnesium, barium, beryllium, scandium, etc. for vacuum applications and VEDs 3-D printer can comprise powder pressed into an optimum form factor for use with the 3-D printer. The 3-D printer can print with different materials in various orders, for example but not limited to, printing with Cu-only and then printing with CuNi or, for example, but not limited to, elemental materials, alloys or compounds, ceramics, etc. of tungsten, copper, aluminum, molybdenum, tantalum, zirconium, gold, silver, nickel, iron, rare earth elements, cobalt, titanium, indium, platinum, palladium, iridium, rhodium, hafnium, zirconium, chromium, silicon, rhenium, osmium, magnesium, barium, beryllium, scandium, etc. to achieve a desired result or a desired or certain part, component, subassembly, assembly, etc. for VEDs including complete VEDs.

Additive manufacturing can be combined/integrated/embedded/incorporated/etc. in the VED parts, components, devices, assemblies, etc. fabrication and manufacturing process(es) in some embodiments.

Materials and processes employed and applied by the 3-D printer include but are not limited to oxide and non-oxide ceramics, powdered metals, by for example but not limited to, laminated object manufacturing (LOM), tape fabrication, laser including precision laser cutting and stacking, lamination and sintering, etc. In some embodiments, robo-casting extrusion, binder jetting, etc. may be used. LOM can also be used for part fabrication.

Additive manufacturing (AM) for ceramics can be used to create 3-dimensional parts, components, subassemblies, assemblies, etc. AM can be used to build and create 3-D forms by, for example, a layer-by-layer fashion. Layering can be accomplished by AM through the deposition and bonding of 2-D layers. AM can be used to fabricate complex shapes. Often complexity results in higher cost; however AM and 3-D printing support and permit complex shapes to be created and implemented typically at low cost with high efficiency.

Binder jetting and material jet printing can be used to create ceramic and insulating parts including integral and integrated parts. Ceramic oxides including alumina and zirconia and related materials as well as ceramic nitrides such as aluminum nitride and silicon nitride may be used in embodiments of the present invention. Powder bed fusion with laser assistance as well as electron beam melting or other forms of directed energy deposition may also be used in embodiments and implementations of the present invention.

Sheet laminations with green state ceramic tapes that are precision cut, stacked and fired can be used in embodiments and implementations of the present invention to realize fine features with tight tolerances. Complex ceramic shapes, parts, components, subassemblies, assemblies, etc. including, but not limited to, those made with alumina and silicon nitride by laminating tapes which are exactly aligned with precision features can also be used in embodiments and implementations of the present invention.

The present invention can use AM processes with digitally sliced 2-D layers. The process of layering is then conducted by the AM system through the deposition and bonding of 2-D layers.

3-D printing could also be used to create helix based devices as well as coupled cavity based devices of all types and designs including essentially all frequencies and bands from less than 100 MHz to greater than 100 GHz and also into the THz range. In addition to traveling wave tubes, the present invention can be used for all types of vacuum electronic devices (VEDs) including, but not limited to, distributed amplifiers, magnetrons, klystrons, crossed-field amplifiers, backward wave oscillators, inductive output tubes, diodes, triodes, tetrodes, pentodes, other gridded tubes including multigridded tubes, microfabricated tubes, solid state vacuum devices (SSVDs), gas tubes, gaseous containing tubes, etc., combinations of these, etc. including both thermionic and field emission of any type as well as photocathode emission based tubes and VEDs, etc.

The present invention can be used to create and fabricate interaction circuits such as those referred to as radio frequency (RF) circuits, interaction circuits, slow wave structures (SWSs), etc. including but not limited to helical structures and coupled cavity structures. The helical structures include but are not limited to helices, ring bar, helical, ring-and-bar and the numerous other variant and types of other ring and/or helical based structures, other types of structures, etc. The coupled cavity structures include but are not limited to tunnel ladders, meander lines, serpentine structures, folded waveguides, etc. The slow wave structures can be fabricated as one piece or multiple pieces. The slow wave structures can be made of all metal or metal and insulators including ceramic insulators that can be 3-D printed including as one piece or one assembly, etc.

The 3-D printer can be used to manufacture any and all types of vacuum tubes, valves, devices, circuits, etc., including but not limited to any and all types of vacuum electron devices (VEDs), any type of cross field electron devices, linear devices, hybrids of any and all types, gyrotrons, klystrons, gridded vacuum tubes, triodes, oscillators, multivibrators, reflex klystrons, magnetrons, traveling wave tubes (TWTs) including any type or form of helix and any type or form of including any ring and/or bar and/or ring bar structure, any and all coupled cavity structures of any type and form of hybrid TWTs, microwave tubes (MWTs), microwave power tube, (MPT), radio frequency vacuum tube, audio frequency vacuum tube, millimeter wave tube, sub millimeter wave vacuum tube, terahertz vacuum tube, backward wave oscillator, vacuum tubes in the frequency range from less than 1 Hz to greater than 10 THz, klystrons of any type and form including extended interaction klystrons (EIKs), EIAs, reflex klystrons, magnetrons of any type and shape and form, etc., combinations of these in any size, type, form, shape, mass, etc., vacuum devices with or without magnets, diodes, triodes, tetrodes, pentodes, higher electrode count, multiple devices in one vacuum tube, envelope, package, etc., sheet beam devices, ribbon beam devices, any and all types of coupled cavity electron devices, any device that transports electron, ions, other positive or negative charges, etc.

The 3-D printer can manufacture parts using, for example but not limited to, ceramic materials including but not limited to Alumina (Al₂O₃), Aluminum Nitride (AlN), Boron Nitride (BN), Beryllium Oxide (BeO)—with proper safety precautions when using BeO, Zirconium Oxide (ZrO), other oxides and nitrides and ceramics, insulators, etc., including combinations of these, etc. and also, in some implementations, fired (i.e., high temperature processed from the green state) during the 3-D fabrication processing and process. In some embodiments of the present invention, 3-D printing of ceramics and metals may be fabricated and/or co-fabricated together, for example, but not limited to, sequentially or simultaneously, etc. to form VED parts, components, subassemblies, full assemblies, etc., including but not limited to, cathodes, heaters, electron guns, focus electrodes, grids, other electrodes, SWS, support rods, capacitive couples, waveguides, vacuum windows, vacuum RF windows, ports, etc., couplers, tuners, collectors, multistage collectors, multistage depressed collectors, vacuum feedthroughs, high voltage feedthroughs, other types of focusing elements, spacers, magnets, periodically permanent magnets (PPMs), magnet spacers, pole pieces, heat sinks, vacuum envelopes, vacuum containers, vacuum housings, loss blocks, filters, tuners, etc.

Materials to be 3-D printed include but are not limited to OFHC Copper, Gold, Aluminum, 304 Stainless Steel, 316 Stainless Steel, silver, Cupronickel, Hastalloy, Monel, Inconel, Nickel, Kovar, Vimvar Core Iron, High Purity Iron, Molybdenum, Tungsten, Magnesium, Nichrome, Chrome, Platinum, Palladium, Fernico, borosilicate glass, aluminum oxide, aluminum nitride, barium, tantalum, strontium, cobalt, zirconium, calcium, beryllium oxide, among others. Materials to be 3-D printed also include but are not limited to those containing elemental materials, alloys or compounds, ceramics, etc. of tungsten, copper, aluminum, molybdenum, tantalum, zirconium, gold, silver, nickel, iron, rare earth elements, cobalt, titanium, indium, platinum, palladium, iridium, rhodium, hafnium, zirconium, chromium, silicon, rhenium, osmium, magnesium, barium, beryllium, scandium, etc. and all other elements, materials, compounds, alloys, materials systems, etc. including materials for getters, ion pumps, pumps, brazing, alloying, bonding, etc. suitable for vacuum use including but not limited to vacuum chambers, vacuum systems, vacuum envelopes, vacuum packages, vacuum load locks, vacuum evaporation and deposition, vacuum electron devices, etc.

3-D printing and additive manufacturing of VED parts, components, subassemblies, assemblies, fixturing, systems, etc. including entire/complete VEDs can involve/include but is not limited to electron beam deposition and/or removal, sputter deposition and or removal, chemical vapor deposition (CVD), other physical vapor depositions (PVD), laser deposition and/or ablation, laser deposition, laser stereolithography, etc. such that metal or the ceramic or both can be layer-by-layer processed to produce metal or ceramic or metal-ceramic components including vacuum tight and leak free metal, ceramic and/or metal-ceramic parts, components, subassemblies, assemblies, fixturing, systems, etc. including entire/complete VEDs. The laser or other light source(s) may have energy and frequencies typically in the UV to infrared region and can be used to for example, but not limited tom polymerizing paste, filament, wire, spools, helices, layers, etc., combinations of these, and other 3-D deposited materials, etc. In other implementations, x-ray sources, induction heating, electron tube heating, electron bombardment heating, and other UV tube sources may also be used as well as ovens and furnaces, and other thermal heating and cooling systems including but not limited to vacuum ovens and furnaces.

In some embodiments of the present invention, one or more combinations and/or hybrids of conventional, micromachined, microfabricated fabrication coupled with 3-D printing/additive manufacturing may be used.

In some embodiments of the present invention, 3-D printing and/or additive manufacturing may be used to repair, rework, seal, replace, augment, enhance, aid, etc. brazing and/or bonding or otherwise join and seal, including vacuum seal, VEDs, parts, components, assemblies, subassemblies, systems, etc. of VEDs, etc.

Inkjet and similar printing may also be combined and used with the present invention to create VED parts, components, subassemblies, assemblies, fixturing, systems, etc. including entire/complete VEDs, to produce metal or ceramic or metal-ceramic components including vacuum tight and leak free metal, ceramic and/or metal-ceramic ones as well as to repair, rework, seal, replace, augment, enhance, aid, etc. brazing and/or bonding or otherwise join and seal, including vacuum seal, VEDs, parts, components, assemblies, subassemblies, systems, etc. of VEDs, etc.

Helices for helix devices may be fabricated using 3-D printing where a spooled or other form or wire or powder, mixtures, etc. is 3-D printed onto a mandrel that is moving, for example, in the axial and radial directions to which the helix material is being screen printed on. As another example, both the helix and the support rods can be 3-D printed including but not limited to simultaneously, sequentially, scheduled, etc. coils of material may be used as well as using the 3-D printer to form materials into coils, helices, ellipses, triangles, squares, parallel pipeheads, cylinders, polygons including but not limited to pentagons, hexagons, octogons, higher and fewer sided structures, etc., arbitrary structures, any type or form of 2D or 3D structure, etc., combinations of these, etc.

The present invention can use any type and form of 3-D printing/additive manufacturing that may currently exist or become available in the future including, but not limited to, selective laser melting (SLM) or direct metal laser sintering (DMLS), selective laser sintering (SLS), fused deposition modeling (FDM), fused filament fabrication (FFF), curing of liquid materials using different techniques and technologies including but not limited to stereolithography (SLA) and laminated object manufacturing (LOM).

Any or all or combinations of any or all of, but not limited to, extrusion, wire, granular, coil, powder bed and inkjet head 3-D printing, laminated, light polymerized, etc. may be used with the present invention as well as techniques and technologies including but not limited to electron-beam melting (EBM), digital light processing (DLP), fused deposition modeling (FDM) or fused filament fabrication (FFF), electron beam freeform fabrication (EBF3), robocasting, Sstereolithography (SLA), laminated object manufacturing (LOM), plaster-based 3-D printing (PP), selective laser sintering (SLS), selective heat sintering (SHS), and direct metal laser sintering (DMLS), among others, which may be used in embodiments and implementations of the present invention.

Materials that may be 3-D screen printed for various parts of the fabrication, creation, assembly, testing, building, making, implementing, manufacturing, testing, packaging, using, operating, supporting, etc. include but are not limited to ceramic materials, metal alloys and compounds, cermets, metal matrix composites, ceramic matrix composites, metal alloys and compounds, stainless steel, other metals including elemental metals mentioned herein, powders including metal powders, metal alloy powders, thermoplastic powder, thermoplastics, plastics, plaster, foils and films including metal, plastic, polymer, photopolymers, cardboard, paper, plastic, etc., thermoplastics including but not limited to PLA, ABS, HIPS, Nylon, HDPE, eutectic metals, other materials, rubber, clay, plasticine, RTV, silicone, ceramic, glass, quartz, sapphire, aluminum, aluminum oxide, aluminum nitride, porcelain, metal clay, precious metals, plastic, etc.

Entire electron guns can be fabricated using the present invention. Using 3-D printing methods discussed herein all components of a modern electron gun including but not limited to ceramics, metal disks, feedthroughs, tuning electrodes, anodes, insulating stand-offs, and magnetic shields may be fabricated in multiple steps to create all parts for a complete assembly. Techniques of the present invention also call for the ability to create multiple-material sub-assemblies such as but not limited to ceramic feedthroughs with 3-D printed conductors already present in the assembly. In this way the 3-D printer may use multiple materials in a single print project to further reduce assembly effort, cost, as well as to reduce the fabrication time demand. The 3-D printed parts may or may not be capable of being metalized by such processes as Molybdenum-Manganese brushing or spraying, other forms of metal diffusion bonding, sputtering, e-beam evaporation, electro-plating, electroless plating, ensuring that the parts may be used as hermetically sealable components for the larger high-vacuum hermetically sealed e-gun assembly. Structures printed by the present invention will be capable of sustaining ultra-high vacuum integrity of greater than 10⁻⁹ Torr indefinitely.

Entire slow wave structures and fast wave structures can be fabricated using the present invention. The present invention is capable of printing small structures with a typical layer resolution around 100 um (250 DPI). Further advancements and future systems will allow this number to decrease to 10 um and down to below 1 um in the future reaching to the nm range. This high resolution even at 100 um and certainly down to sub 1 um allows the 3-D printer to be used to create sophisticated RF interaction structures for both slow wave structure (SWS) and fast wave structure (FWS) applications. Unlike traditional fabrication techniques involving the removal of material from a bulk source, the 3-D printer can create the structures layer by layer with great accuracy. Metals such as OFHC Cu, Ni, Mo, Fe, CuNi, and many other metals and alloys can be printed to create any SWS or FWS desired. The 3-D printer may also be used to directly print RF lossy material such as solid blocks or layers of RF lossy material directly onto the RF interaction structures thereby removing a difficult and costly process of adding loss to an interaction structure after the base structure is fabricated. One large advantage of using the 3-D printer for building vacuum amplifying structures is that it removes the need for brazing, or otherwise joining in any other fashion, multiple parts that comprise the amplifying structure. With the present invention, a hermetically sealed wave interaction structure may be printed without the need for creating multiple parts for a larger assembly. The entire structure may be printed and the completed SWS, FWS, etc. may be directly used after printing, fully fabricated with loss loading sections, RF severs, waveguide tapers, waveguide flanges, tapers, RF tapers and windows, etc., hidden cavities, and any other RF structure that is pertinent to the design. The present invention can reduce the time to fabricate such structures by days or weeks, with an entire assembly being able to be printed in a matter of hours or even less.

Entire collectors including multistage depressed collectors can be fabricated using the present invention. Electron collector assemblies used with VEDs consist of one or many conductive plates that serve to either deflect or collect an incoming electron beam. A typical collector is constructed of an outer vacuum shell of ceramic or metal, and the inside consists of the collector stage or stages. The present invention can fabricate all parts necessary to build a modern single stage or multiple stage depressed collector (MDC) including wires and the connections to the wires and vacuum feed throughs including electrical, mechanical, liquid and all other types and forms of feedthroughs and electrode and RF (including from less than 1 Hz to greater than 10 THz) and/or DC electrical connections. In a similar fabrication process to that of the e-gun, the collector may be constructed by first 3-D printing all pertinent parts belonging to an assembly. Then the parts may be assembled in a traditional fashion by fastening, welding, brazing, bonding, gluing, etc. the sub-assembly components together or may use 3-D printing and/additive processes including PVD and/or CVD, plating, combinations of these, etc. The 3-D printer is also capable of printing entire collector assemblies in one process run by using different materials including insulating and conducting materials to construct the main collector components such as the body, collector stages, high voltage feed-through, and gas evacuation tubes as a single assembly.

Entire VEDs can be fabricated using the present invention. The final object of the present invention is the ability to combine all of the abilities of the printer to enable the fabrication of an entire VED assembly in a single print job. With a few exceptions such as the cathode material, a few varieties of RF lossy material, getter materials, and other advanced materials, the present invention is capable of printing the majority of the structures required in the fabrication of traditional VED's. As described herein, methods to produce entire electron guns, interaction wave circuits, collectors, as well as connection tubes such as pinch-off tubing for high vacuum bake-out operations can be joined together to produce an entire structure in a single print job. Materials and parts that are not feasible to create using 3-D printing may be installed into the assembly to complete a working device. Currently VED development requires a major investment in both time and money for the acquisition of part design, process and machinability procurement for each part, long lead times for the parts, and after all this there are many times issues resulting in the reliability and the precision of parts available after vendors have machined and delivered the parts. Many times out of specification parts result in a VEDs performance being drastically altered and can result in the total failure of a tube. The present invention can precisely make most parts needed for the fabrication of these tubes and devices, and at a fraction of the cost and time. The ability to simply reprint a VED part or complete assembly when needed removes the long lead time delay and expedites the research and development time frame needed for the design of new, more efficient VEDs. The present invention also allows for rapid time to market for mature VED designs when a constant reliable source of high precision parts is required. The ability to simply print parts on demand represents an advantage that has not been possible especially for complex vacuum tube design.

VEDs that can be fabricated using the present invention include but are not limited to:

Klystron
Reflex klystron
Two-cavity klystron
Multi-cavity klystron
Extended interaction klystron (EIK)
Extended Interaction Oscillator (EiO)
Carcinotron (http://www.radartutorial.eu/druck/Book5.pdf)
Magnetron (Diode oscillator)
Traveling-Wave tube

Ring-loop TWT
Ring-Bar TWT
Coupled-cavity TWT
Helix TWT
Folded-waveguide TWT

Backward-Wave Oscillator
Negative-resistance magnetron
Electron-resistance magnetron
Crossed-Field Amplifier (http://www.radartutorial.eu/druck/Book5.pdf)
Amplitron
Platinotron
Stabilotron
Tunnel Diode Devices
Tunnel-diode oscillators
Tunnel-diode amplifier
Varactor
Parametric frequency converter
Avalanche transit-time diodes
Point-contact diode
Microwave transistor

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A vacuum electronic device manufacturing system comprising a three dimensional printer.
